(19) United States
(12) Patent Application Publication
(10) Pub. No.: US 2002/0005455 A1
(43) Pub. Date: Jan. 17, 2002

(54) Rotor control with negative collective in high speed auto-rotation

(76) Inventor: Jay W. Carter JR., Burkburnett, TX (US)

Correspondence Address: James E. Bradley, BRACEWELL & PATTERSON, L.L.P., P.O. Box 61389, Houston, TX, 77208-1389, US

(21) Appl. No.: 09/862,566

(22) Filed: May 22, 2001

Related U.S. Application Data
(60) Provisional application No. 60/207,025, filed on May 25, 2000.

(51) Int. Cl. B64C 27/22

(52) U.S. Cl. 244/8

(57) ABSTRACT

A method of operating a rotor aircraft at high speeds applies negative collective pitch to the rotor. The rotor aircraft has a wing, a thrust source and a rotor. During horizontal flight, the pilot operates the thrust source to move the aircraft forward. This supplies lift due to air flowing over the wing. By controlling tilt of the rotor, and without supplying power to the rotor, the pilot causes the rotor to auto-rotate due to the forward movement of the aircraft. The speed of rotation of the rotor is controlled by the degree of tilt of the rotor relative to the direction of flight. Once the aircraft speed is sufficiently high to cause reverse flow of air over the entire retreating blade of the rotor, the pilot reduces the collective pitch of the rotor to less than zero to reduce the flapping as desired.

This invention claims the priority date of provisional application Ser. No. 60/207,025, filed May 25, 2000.

### FIELD OF INVENTION

This invention relates to methods and apparatus for improving the performance of rotary wing aircraft.

### BACKGROUND OF THE INVENTION

The quest for faster rotor aircraft has been ongoing ever since Juan de la Cierva invented the autogyro in 1923. One basic problem is that a rotor's lift is limited by the lift that can be produced by the retreating blade, since the aircraft will roll if the total lift moments on the advancing blade do not equal the total lift moments on the retreating blade. At high aircraft forward speeds, the retreating blade tends to stall and lose lift, because the rotor rotation rate cannot be increased without the advancing blade tip going faster than the speed of sound. Because of this problem, the ratio of aircraft forward speed to rotor rotational tip speed ratio, known as Mu, is limited to about 0.5 in helicopters and in conventional autogyros without wings.

The gyroplane, described in U.S. Pat. No. 5,727,754, has an auxiliary thrust means, such as an engine driven propeller, and a wing in addition to the rotor. The rotor is powered by the engine only while the aircraft is on the ground. The momentum of the spinning rotor plus providing a positive collective pitch provides lift for vertical takeoff. The aircraft moves forward due to the driven propeller, with airflow over the wing providing lift. The rotor continues to rotate, but in auto-rotation due to the airflow past the blades of the rotor. The wing thus reduces the need for rotor lift during horizontal flight, reducing the problems with retreating blade stall. The '754 patent teaches that the rotor auto-rotation rate can be reduced from conventional helicopters during forward flight, which is an advantage since the rotational drag of a rotor blade to the aircraft increases with the cube of the rotation rate. The challenge, then, is to maintain auto-rotation and rotor stability given a low rotor rotation rate combined with high aircraft forward speed.

### SUMMARY OF THE INVENTION

It is the general object of the invention to provide an improved gyroplane capable of achieving high speeds.

In general, this object is achieved by varying collective pitch, including to negative values, to maintain acceptable levels of flapping at high aircraft forward speeds and low rotor rotation rates, or adjusting or maintaining the rotor rotation rate by automatically controlling the tilt of the rotor disk relative to the airstream or aircraft, or a combination of these techniques.

### BRIEF DESCRIPTION OF THE DRAWINGS

FIG. 1 is a perspective view of a high-speed rotor aircraft constructed in accordance with this invention.

FIG. 2 is a schematic plan view of a low speed rotor aircraft, with an advancing blade having a Mu ratio less than 1.

FIG. 3 is a schematic plan view of a high speed rotor aircraft constructed in accordance with this invention with an advancing blade having a Mu ratio greater than 1.

FIG. 4 is a schematic side view illustrating the advancing blade at zero collective with vectors showing forward speed, rotational speed, flapping, lift, drag, and driving force.

FIG. 5 is a schematic side view illustrating the retreating blade at zero collective having airflow over the leading edge first at a Mu ratio of about 0.5, and showing vectors of forward speed, rotational speed, flapping, lift, drag, and driving force.

FIG. 6 is a schematic side view illustrating the retreating blade at zero collective having airflow over the trailing edge first at a Mu ratio of about 2.0, and showing vectors of forward speed, rotational speed, flapping, lift, drag, and driving force.

### BEST MODE FOR CARRYING OUT THE INVENTION

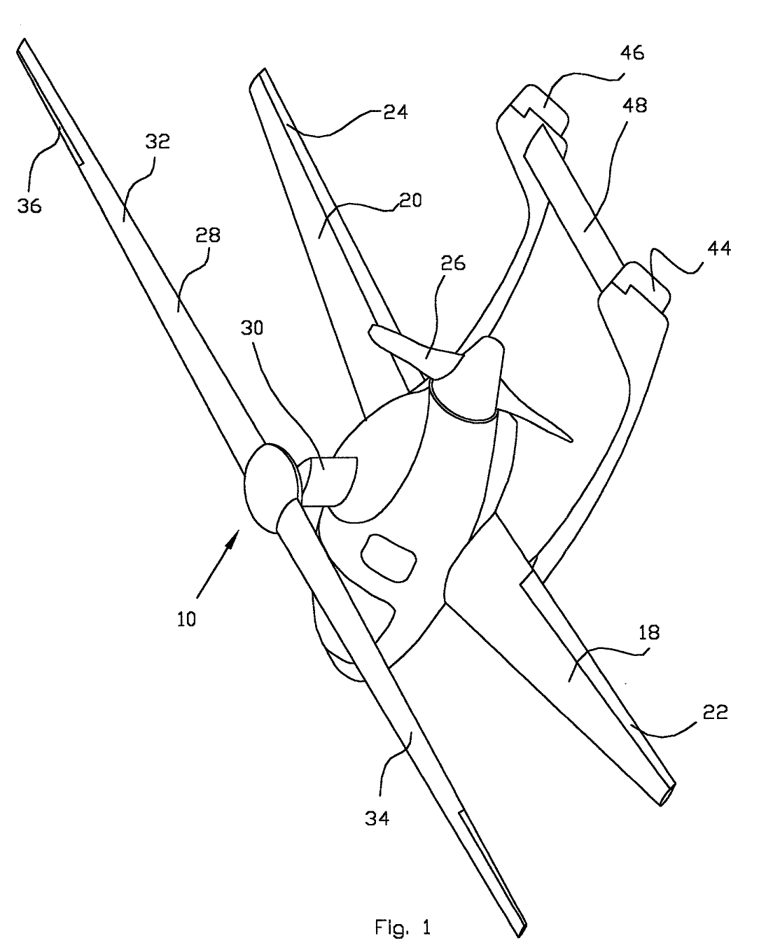

Referring to FIG. 1, a high-speed rotor aircraft 10 of this invention is generally constructed with the technology disclosed in U.S. Pat. No. 5,727,754. Aircraft 10 has a wing, which in this embodiment comprises two separate wings 18, 20 extending from opposite sides of a fuselage. Each wing 18, 20 has an aileron 22, 24, respectively. A propeller 26 supplies thrust to move aircraft 10 in a forward direction. In this embodiment, propeller 26 is a pusher type, but it could also be a pulling type. Furthermore, a turbojet for supplying thrust is also possible.

Aircraft 10 also has a rotor 28 that rotates in a plane or disk generally perpendicular to propeller 26. The disk defined by the rotation of rotor 28 may be somewhat cone-shaped, but is referred to herein for convenience as a plane of rotation. As rotor 28 rotates, there will be an advancing blade 32 that moves into the direction of forward flight and a retreating blade 34 that moves in an opposite direction. A series of weights 36 are mounted near the tips of blades 32, 34 to stiffen the blades due to centrifugal force. Aircraft 10 also has a pair of tail booms with rudders 44, 46 on each. A horizontal stabilizer 48 extends between the tail booms.

The pilot can control various aspects of craft 10 including:

the forward to rearward tilt and side to side tilt of rotor 28 using a mechanism known to those skilled in the art as a tilting spindle;

the relative angle of attack of rotor blades 32, 34 to the rotor plane of rotation known to those skilled in the art as collective pitch;

the relative horizontal angle of each aileron 22, 24 and horizontal stabilizer 48; and

the relative vertical angle of rudders 44, 46.

In operation, for a vertical or near vertical takeoff, the pilot will rotate rotor 28 at a fairly high speed as well as rotating propeller 26 while holding brakes to prevent forward movement. Once rotor 28 is spinning at a high enough rate, the pilot introduces positive collective pitch to rotor 28, releases the brakes, and releases a clutch that engages rotor 28 with the engine. The momentum of the spinning rotor 28 provides lift, causing the aircraft to rise, while propeller 26 simultaneously moves aircraft 10 forward. Air flowing over wings 18, 20 creates lift. The forward motion of aircraft 10 also causes rotor 28 to rotate as air flows past blades 20, 22. This freewheeling of rotor 28 is referred to herein as auto-rotation. Rotor 28 carries most of the aircraft weight during vertical and slow speed flight. However, unlike a conventional helicopter or autogyro which relies on only its rotor for lift, rotor 28 of craft 10 is greatly unloaded (provides less than 20% of the lift) at high speed and wings 18, 20 provide the balance of the lift. Rotor 28 can be slowed (to 125 rpm or less) during high-speed flight to greatly reduce the drag of rotor 28 and enable craft 10 to reach higher speeds than those relying on the rotor alone for lift. This is discussed below in greater detail.

The rotor is slowed and unloaded by reducing the collective pitch of blades 30, 32 to or below zero, and by tilting rotor 28 forward. When collective pitch is changed, each blade 32, 34 will pivot about a center line or radial line of rotor 28 that extends from one tip of rotor 28 to the other. Blades 32, 34 will pivot in opposite directions to each other so that when the retreating blade 34 becomes the advancing blade 32, it will be at the desired pitch relative to the rotor plane or disk. A positive collective results in the leading edge of advancing blade 32 being above the rotor disk and its trailing edge below the rotor disk. Similarly, a positive collective results in the leading edge of retreating blade 34 being above the plane of rotation and the trailing edge below the plane of rotation.

During auto-rotation, the tilt of rotor 28 is controlled to maintain the rate of rotation. As the airspeed increases, wings 18, 20 provide more of the required lift. At some speed, wings 18, 20 could provide all of the lift, however, at no point during flight is rotor 28 stopped because rotor 28 would become unstable. Since rotor 28 continues to turn in auto-rotation, it will also provide some lift.

FIG. 2 depicts a schematic of a prior art rotor aircraft 112, such as a helicopter, in flight. The aircraft of FIG. 2 relies entirely on the rotor 114 for lift, and rotor 114 is driven at all times by an engine. A tail blade 115 counters torque produced by the driven rotor 114. Rotor 114 rotates counterclockwise and aircraft 112 travels toward the left as viewed in FIG. 2. Therefore, advancing blade 116 is said to be the advancing blade since rotation makes it move in the direction of aircraft 112 travel. Similarly, retreating blade 118 is said to be the retreating blade because rotation moves it in the direction opposite of aircraft travel. A particular point on advancing blade 116 travels through the air at a speed which equals the forward speed of aircraft 112 plus the rotational speed of that point on the blade. A particular point on retreating blade 118 travels through the air at a speed equal to the forward speed of aircraft 112 minus the rotational speed of that point on the blade. Therefore, any point on the advancing blade 116 is always moving through the air faster than the same point on the retreating blade 118. Furthermore, as we consider various points along each rotor blade 116, 118, each point is traveling through the air at a different speed because its rotational speed depends on that point's distance from the center of rotation.

Still referring to FIG. 2, vector A represents the forward speed of aircraft 112, and vectors B, C represent the rotational speeds at the tips of rotor 114. Vectors B and C have the same magnitude. The ratio of forward speed A to rotational tip speed B,C, is an important ratio known as Mu. In FIG. 2, Mu is approximately 0.5, which is about the maximum achievable in a standard helicopter or autogyro. The horizontal distance measured parallel to the direction of flight and between line F and the centerline 119 of rotor 114 represents the rotational speed at any point along the rotor. The horizontal distance measured parallel to the direction of flight and between line G and the centerline 119 of rotor 114 represents the speed through the air at any point along the rotor. At the point where line G crosses the centerline 119 of rotor 114, the speed through the air is zero. At all points from there to the inboard end of the retreating blade, in region K of the blade, the airflow over the blade actually travels from the trailing edge to the leading edge of the blade, opposite to the normal direction of flow over an airfoil. Regions H and J are traveling through the air in the normal direction and are producing lift.

Helicopters and autogyros (as opposed to gyroplanes) are limited to a Mu of approximately 0.5 because the rotor always has to provide a large amount of lift, and the total lift moment of the advancing blade must equal the total lift moment of the retreating blade. The lift of a section of a rotor blade is a function of the square of the speed through the air of that section, and the pitch angle to the oncoming air (angle of attack) of that section. The lift is also a function of the position of the rotor blade in its rotation, but this effect is so difficult to calculate that it is will be ignored. At a Mu of 0.5, only regions J and H are generally producing lift, and region J is both smaller and moving more slowly through the air than region H, so it becomes difficult to maintain rotor lift equilibrium. Therefore it is impossible for a conventional helicopter or autogyro, which has to produce a significant amount of lift with its rotor, to achieve a Mm of 1.

For the lift on the advancing and retreating blades to be equal at high Mu, the angle of attack of retreating blade 118 must be increased or the angle of attack of the advancing blade 116 must be decreased, or both. Automatic equalization of the lift is accomplished in the prior art using flapping on autogyros and helicopters. The preferred flapping mechanism is one or more teetering or flapping hinges perpendicular to the center of rotation, which allows the advancing blade 114 to move upward, thereby decreasing its angle of attack and lift, while simultaneously moving the retreating blade downward 118, thereby increasing its angle of attack and lift. This self-equalization of the lift is limited however, since the amount of flapping is mechanically limited, and also because the lift of the retreating blade does not increase when the angle of attack becomes greater than approximately 8 to 16 degrees, because the airfoil stalls.

Another prior art method of delaying retreating blade stall is to increase the rotational speed of the rotor. However, the top speed of a rotor aircraft is limited by drag on the advancing blade 118 as it approaches the speed of sound. As the aircraft speed, vector A, increases, the advancing tip speed D approaches the speed of sound and the aerodynamic drag on advancing blade 116 increases dramatically. Furthermore, the rotational drag of a rotor on the aircraft is generally a function of the cube of its rotation rate, so a faster rotor rotation rate will cause more drag even when the advancing blade does not approach the speed of sound. Therefore, the key to faster flight is to decrease, not increase the rotor rotation rate. However, the rotor cannot be allowed to turn too slowly or it will break when aerodynamic forces acting out of the plane of rotation exceed the centrifugal forces.

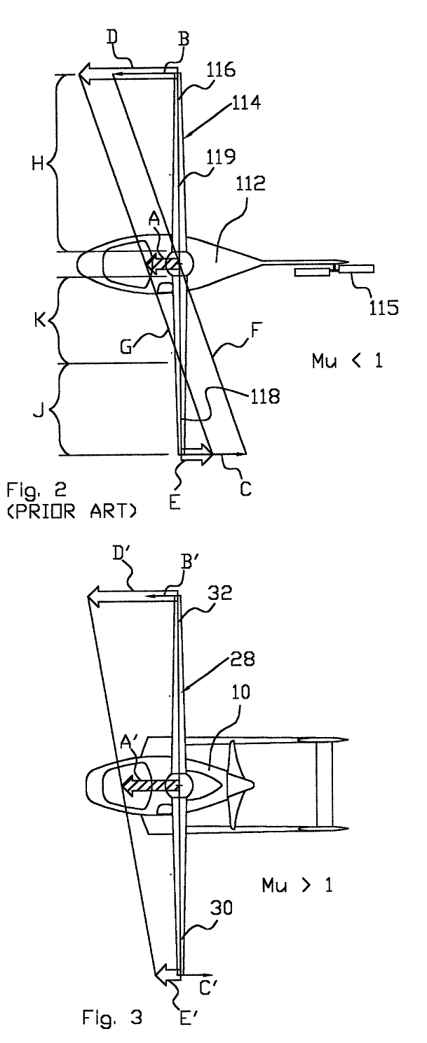

Referring to FIG. 3, an aircraft 10 of this invention can be stable as Mu approaches and exceeds 1.0 because rotor 28 does not have to produce much lift or thrust during high speed flight. Thus, rotor 28 can be allowed to turn at a very low rotation rate (vectors B and C) and the rotor disk can be maintained at a very shallow angle of attack required only to keep rotor 28 autorotating. The minimum rotor rotation rate is that which produces the blade centrifugal force necessary to keep rotor 28 stiff and stable. The pilot is warned when the rotation rate is getting low because the rotor will begin to hit bumpers attached to the mechanical flapping stops.

At this point the pilot can increase the rotor rotation rate by tilting the spindle back. However, this will result in an increase in drag and slower forward speed. Alternately, the pilot can reduce collective even to a negative value. At high speeds, the negative value of collective reduces the lift on the advancing blade 32, and increases the lift on the retreating blade 28 since it is in reverse flow. That equalizes the lift on the two blades and reduces flapping.

Rotor blade 28 remains in auto-rotation at a constant rotation rate if the driving and retarding forces caused by lift and drag, measured in the plane of rotation, are equal. Since the oncoming air approaches at a different speed and angle of attack at each location on the rotor blade 28, and at each position in the rotation of that rotor blade, only a numerical model can competently predict the conditions under which auto-rotation will continue. The inventor has developed a computer model and has tested a physical scale model in a wind tunnel, and determined that auto-rotation, stability, and gust tolerance can be maintained at high Mu ratios of at least 0.75 and preferably between about 1.0 and 5.0.

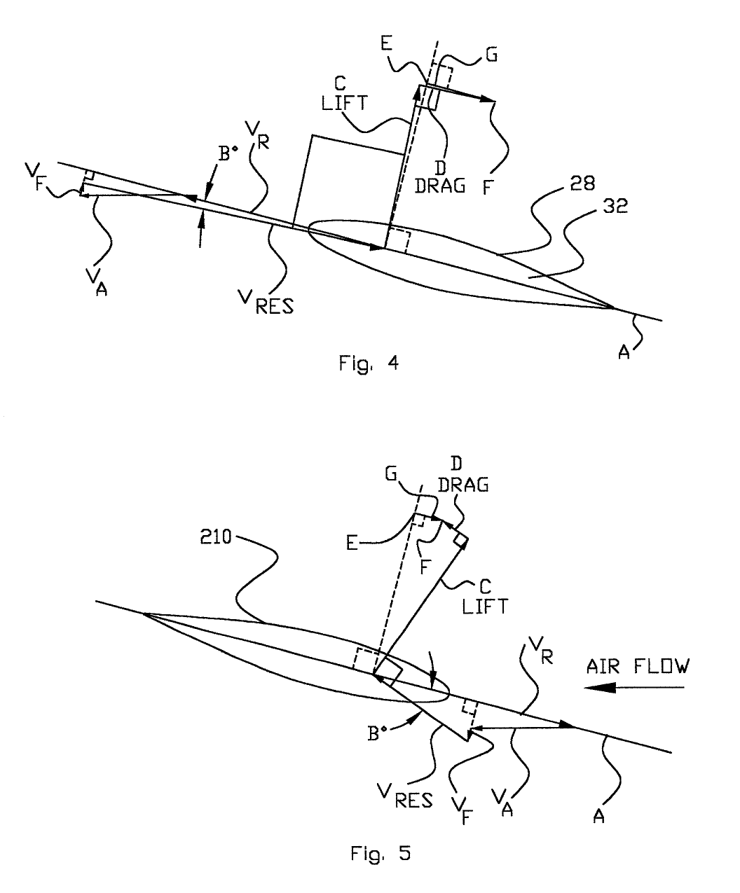

FIGS. 4 through 6 and their accompanying discussion illustrate how rotor 28 can equalize lift between the advancing and retreating blades, and also illustrates how to calculate when auto-rotation will occur. In FIGS. 4 through 6, line A represents the rotor plane of rotation, which is tilted as it must be for an autogyro traveling toward the left, although the tilt is greatly exaggerated. Rotor 28 is operating at a collective pitch of zero degrees relative to the rotor plane of rotation A. Thus a chord passing through the leading and trailing edges will be in the rotor disk A. Vector Vr represents the rotational speed of this section, and is along the plane of rotation. Advancing blade 32 of rotor 28 is shown, and Vector Va represents the forward speed of the aircraft, which is horizontal. Vector Vf represents the movement of this section perpendicular to the plane of rotation due to flapping. The sum of vectors Vr, Va, and Vf results in vector Vres, which is the resultant velocity of the air as it impinges on this section.

In general, lift equalization occurs because of flapping. Flapping is the upward movement of advancing blade 32, reducing its angle of attack and lift, and simultaneous downward movement of retreating blade 34 (FIG. 5), increasing its angle of attack and lift.

FIG. 4 shows a cross section of advancing blade 32 near the tip, and is illustrative of the conditions for any section of the advancing blade at any Mu. The angle of attack B of this section is the angle between vector Vres and the plane of rotation A. Note that the addition of flapping vector Vf results in a smaller angle of attack B than would otherwise be present, which results in less lift for this section. Therefore, flapping has reduced the lift of this section. Similarly, if collective were negative, the airfoil would be tilted further counterclockwise, which would also result in a smaller angle of attack B and would reduce flapping. If collective were negative, the leading edge of advancing blade 32 would be below the plane of rotation A, and the trailing edge of the retreating blade 34 would be above the plane of rotation A.

Lift is always defined to be perpendicular to the airflow, and drag is parallel to airflow. Still referring to FIG. 4, vector C (perpendicular to vector Vres) represents the lift of advancing blade 32 at the cross-section shown, and vector D (parallel to Vres) represents the drag of that section. The component of the lift and drag in the plane of rotation A is represented by vector G that extends between points E and F. Since vector G points opposite to the direction of rotation of rotor 28, it is shown as a resisting force and will act to slow auto-rotation. However, the actual lift to drag ratio of the advancing blade 32 at that point and the angle of attack B determine whether the force is driving or resisting. Mathematically, if the angle of attack B is greater than the arctangent of the quantity of drag D divided by lift C, then this section will provide a driving force. Negative collective would reduce the resisting force in this example.

FIG. 5 shows a cross section of the retreating blade under conditions where flow over the blade is in the normal direction, from the leading edge to the trailing edge. This low flight speed condition will occur near the retreating blade 34 tip when Mu is much less than 1. The angle of attack B of this section of retreating blade 34 is the angle between vector Vres and the plane of rotation A. Note that the addition of flapping vector Vf results in a larger angle of attack B than would otherwise be present, which results in more lift for this section (unless it is already stalled). Therefore, flapping generally increases the lift of this section. Negative collective would not be used in this condition because forward flow on the retreating blade would only occur at low airspeeds; it would also not decrease flapping. Negative collective would result in advancing blade 34 being tilted clockwise from the position shown in FIG. 5.

Still referring to FIG. 5, lift C acts perpendicular to vector Vres (the oncoming air), and drag D acts parallel to it. Therefore, the force in the plane of rotation A due to lift and drag is vector G. Vector G acts in the direction of rotation, so it is a driving force. However, depending on the ratio of lift to drag and on the angle of attack, the actual force may be driving or resisting. Again, if the angle of attack B is greater than the arctangent of the quantity of drag D divided by lift C, then this section will provide a driving force. Negative collective increases the driving force (or reduces the resisting force).

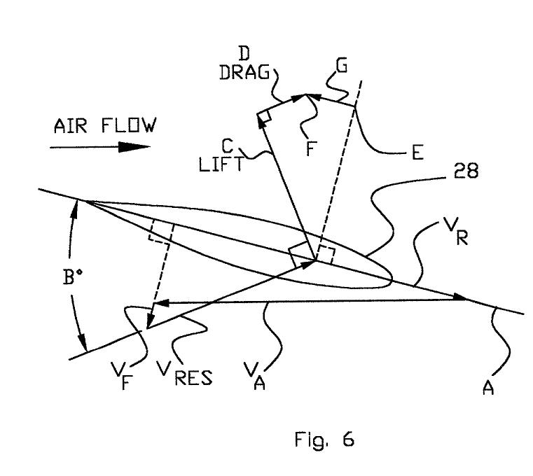

FIG. 6 shows a cross section of retreating blade 34 under conditions where flow over the blade is in the reverse direction, from the trailing edge to the leading edge. This condition will occur near the retreating blade root at any Mu, and propagate toward the tip as the Mu increases, until it exists on the entire retreating blade 34 at a Mu greater than 1. Since the flow is generally from the trailing edge to the leading edge, the airfoil will operate inefficiently but will still provide some lift. The angle of attack B is the angle between vector Vres and plane of rotation A. Note that the addition of flapping vector Vf still increases angle of attack B and therefore tends to increase lift. Negative collective would tilt the airfoil more clockwise and increase its angle of attack, thereby increasing lift and decreasing flapping. The leading edge of retreating blade 34 will be below the plane of rotation A and its trailing edge above if the collective is negative.

Still referring to FIG. 6, lift C acts perpendicular to vector Vres (the oncoming air), and drag D acts parallel to it. Therefore, the force in the plane of rotation due to lift and drag is vector G. Vector G acts opposite to rotation, so it is a resisting force. However, depending on the ratio of lift to drag and on the angle of attack, the actual force maybe driving or resisting. Unlike in FIGS. 4 and 5, in FIG. 6, if the angle of attack B is less than the arctangent of the quantity of drag D divided by lift C, then this section will provide a driving force. Since the drag of the airfoil operating in reverse is generally high, angle of attack B can generally be relatively high and still result in a driving force. Negative collective would reduce the resisting force or increase the driving force.

Consequently, during horizontal flight, once the speed of aircraft 10 (FIG. 1) reaches a sufficient level, the pilot will tilt rotor 28 forward to reduce rotation speed to a desired auto-rotation level and reduces collective pitch to zero. As the aircraft speed continues to increase the retreating blade will develop a Mu greater than 1.0 over its entire length. As the Mu increases above 1.0, the pilot may reduce the collective pitch to a negative amount to reduce flapping. The pilot will control tilt of the rotor to regulate the rotor rpm to keep the tip of the advancing blade below the speed of sound. At slower forward speeds, when the rotor has a Mu substantially less than 1.0, the pilot will increase the collective pitch to zero or a positive amount.

The invention has significant advantages. By applying a negative collective, lift of the advancing blade decreases and lift of the retreating blade decreases, reducing flapping of the rotor. This allows the pilot to tilt the rotor forward more to further reduce rotor rpm, rotor drag, advancing tip speed and allowing the aircraft to fly faster.

While the invention has been shown in only one of its forms, it should be apparent to those skilled in the art that it is not so limited but is susceptible to various changes without departing from the scope of the invention.

I claim:

1. A method of operating a rotor aircraft at high speeds, the rotor aircraft having a wing, a thrust source and a rotor, the method comprising:
(a) operating the thrust source to move the aircraft forward;
(b) supplying lift due to air flowing over the wing;
(c) without supplying power to the rotor, causing the rotor to rotate due to the forward movement of the aircraft;
(d) controlling the speed of rotation of the rotor by tilting the rotor relative to the direction of flight; and
(e) reducing collective pitch of the rotor to less than zero.

2. The method according to claim 1, wherein the amount of collective pitch applied in step (e) is selected to limit a degree of ascent of an advancing blade of the rotor and simultaneously limit a degree of descent of a retreating blade of the rotor.

3. The method according to claim 1, wherein step (e) results in each of the advancing and retreating blades of the rotor having a leading edge below and a trailing edge above a plane of rotation of the rotor.

4. The method according to claim 1, wherein the speed of rotation of the rotor and the forward velocity of the aircraft are controlled to achieve a Mu of 0.75, whereby three-fourths of the length of the retreating blade of the rotor has reverse flow.

5. The method according to claim 1, wherein the speed of rotation of the rotor and the forward velocity of the aircraft are controlled to achieve a Mu of 0.1, whereby the entire length of a retreating blade of the rotor has reverse flow.

6. The method according to claim 1, wherein the speed of rotation of the rotor and the forward velocity of the aircraft are controlled such that a retreating blade of the rotor will experience reverse airflow throughout its entire length.

7. A method of operating a rotor aircraft at high speeds, the aircraft having a wing and a rotor that rotates in a rotor plane, comprising:
(a) supplying thrust to move the aircraft forward at a sufficient velocity to create lift due to air flowing over the wing;
(b) tilting the rotor plane rearward to maintain an angle of attack sufficient to keep the rotor turning in auto-rotation at a rate that results in reverse air flow over a retreating blade of the rotor substantially to its tip; and
(c) reducing collective pitch on the rotor to below zero to reduce lift created by an advancing blade and increase lift created by the reverse flow across the retreating blade.

8. The method according to claim 7, wherein the amount of tilt, speed of rotation of the rotor, and the forward velocity of the aircraft are controlled to maintain a tip speed of the advancing blade to less than a speed of sound.

9. The method according to claim 7, further comprising:
allowing the advancing blade to rise, thereby reducing its angle of attack and lift, and allowing the retreating blade to descend, thereby increasing its angle of attack and lift.

10. A method of operating a rotor aircraft at high forward speeds, the aircraft having a wing, and a rotor that rotates within a rotor disk, defining an advancing blade and a retreating blade, the method comprising:
(a) supplying thrust to move the aircraft forward at a velocity that creates lift due to air flowing over the wing;
(b) tilting the rotor disk to a degree that causes the rotor to autorotate due to airflow across the rotor disk;
(c) reducing collective pitch of the rotor such that the advancing blade and the retreating blades have their leading edges below the rotor disk and trailing edges above the rotor disk;
(d) allowing the advancing blade to rise to decrease lift caused by the advancing blade and allowing the retreating blade to fall to increase lift caused by the retreating blade; and
(e) controlling steps (a) through (c) to cause the airflow across the retreating blade to be from the trailing edge to the leading edge substantially to a tip of the retreating blade.

11. The method according to claim 10, wherein steps (b) and (c) are controlled such that an amount of lift created by auto-rotation of the rotor is substantially less than the lift created due to air flowing over the wings.

12. The method according to claim 10, wherein the amount of tilt, speed of rotation of the rotor, and the forward velocity of the aircraft are controlled to maintain a tip speed of the advancing blade to less than a speed of sound.
